(19) United States
(12) Patent Application Publication
(10) Pub. No.: US 2013/0051651 A1
(43) Pub. Date: Feb. 28, 2013

(54) QUANTITATIVE IMAGE ANALYSIS FOR WOUND HEALING ASSAY

(71) Applicants: James F. Leary, West Lafayette, IN (US); Michael David Zordan, Champaign, IL (US)

(72) Inventors: James F. Leary, West Lafayette, IN (US); Michael David Zordan, Champaign, IL (US)

(73) Assignee: PURDUE RESEARCH FOUNDATION, West Lafayette, US (US)

(21) Appl. No.: 13/696,089

(22) PCT Filed: May 7, 2011
(86) PCT No.: PCT/US11/35663

§ 371 Date: Nov. 5, 2012

Related U.S. Application Data
(60) Provisional application No. 61/332,399, filed on May 7, 2010.

(51) Int. Cl. G06K 9/00

(52) U.S. Cl. 382/133

(57) ABSTRACT

Illustrative embodiments of a method are disclosed, which comprise applying a texture filter to a bright field image of a wound healing assay, generating a wound mask image in response to an output of the texture filter, and determining a wound area of the wound healing assay by counting a number of pixels in the wound mask image corresponding to the wound area. Illustrative embodiments of apparatus are also disclosed.

### CROSS REFERENCE TO RELATED APPLICATION

This application claims priority to U.S. Provisional Patent Application No. 61/332,399, filed May 7, 2010, the entire disclosure of which is hereby incorporated by reference.

### GOVERNMENT RIGHTS

Part of the work during the development of this invention was funded with government support from the National Institutes of Health under grants1S10RR023651-01A2 and R01CA114209. The U.S. Government has certain rights in the invention.

### TECHNICAL FIELD

The present disclosure relates generally to a quantitative image analysis algorithm for a wound healing assay and, more particularly, to a quantitative image analysis algorithm that uses a texture filter to distinguish between areas covered by cells and the bare wound area in a bright field image.

### BACKGROUND ART

The wound healing assay is a common method to assess cell motility that has applications in cancer and tissue engineering research. For cancer research, it provides a measure of the aggressiveness of metastasis, allowing a rapid in-vitro testing platform for drugs that inhibit metastasis. For burn patients, it provides a way to assess not only the speed of tissue re-growth but also a quantitative measure of the quality of wound repair, which may provide prognostic information about wound healing outcomes in these patients.

The wound healing assay, or “scratch” assay, is a traditional method used to study cell proliferation and migration. This method is described, by way of example, in G. J. Todaro et al., “The Initiation of Cell Division in a Contact-Inhibited Mammalian Cell Line,” 66 J. Cellular & Comparative Physiology 325-33 (1965); M. K. Wong et al., “The Reorganization of Microfilaments, Centrosomes, and Microtubules During In Vitro Small Wound Reendothelialization,” 107 J. Cell Biology 1777-83 (1988); and B. Coomber et al., “In Vitro Endothelial Wound Repair: Interaction of Cell Migration and Proliferation,” 10 Arteriosclerosis Thrombosis & Vascular Biology 215-22 (1990), the entire disclosures of which are each incorporated by reference herein. In a traditional wound healing assay, cells are seeded into a vessel—typically, a small Petri dish or a well plate—and allowed to grow to a confluent monolayer. A pipette tip is then used to scratch this monolayer to create a wound area that is free of cells. The cultures are then imaged over time using bright field or fluorescence microscopy to monitor the growth and migration of cells into the wound as it is healing.

The analysis of these wound images has proven to be problematic because of a lack of truly quantitative data analysis. The most common way to measure wound healing is to manually measure the distance between edges of the wound and calculate the wound area, as described in X. Ronot et al., “Quantitative Study of Dynamic Behavior of Cell Monolayers During In Vitro Wound Healing by Optical Flow Analysis,” 41 Cytometry 19-30 (2000), and M. B. Fronza et al., “Determination of the Wound Healing Effect of Calendula Extracts Using the Scratch Assay with 3T3 Fibroblasts.” 126 J. Ethnopharmacology 463-67 (2009), the entire disclosures of which are each incorporated by reference herein. This method has many drawbacks. First, the method is manual and very tedious which limits the ability to perform high throughput wound healing assays. The second drawback is that the manual selection of the edge of the wound is very subjective, varying depending on the person performing the measurement. A third problem is that the area calculation assumes that the wound has a rectangular shape with smooth edges, which is almost never the case. Because of these problems, wound healing assays are typically low throughput tests, and the data obtained is subjective and can only provide qualitative results.

There have been several attempts made to address these problems. C. R. Keese et al., “Electrical Wound-Healing Assay for Cells In Vitro,” 101 Proceedings Nat'l Academy Scis. 1554-59 (2004), the entire disclosure of which is incorporated by reference herein, describes an electrical wound healing assay that wounds a cell monolayer by lethal electroporation and monitors the wound healing by measuring the surface resistance using microelectrodes. This technique is quantitative and highly reproducible, but the throughput is low and this assay requires expensive, specialized equipment that is not common in most laboratories.

J. C. Yarrow et al., “A High-Throughput Cell Migration Assay Using Scratch Wound Healing: A Comparison of Image-Based Readout Methods,” 4 Biotechnology 21 (2004), the entire disclosure of which is incorporated by reference herein, discusses high-throughput scanning methods that perform the wound healing assay in 96 and 384 well plates, which are measured using fluorescence scanners. The assays, however, all require that the cells are labeled with a fluorescent probe.

T. Geback et al., “Edge Detection in Microscopy Images Using Curvelets,” 10 BMC Bioinformatics 75 (2009) and T. Geback et al., “TScratch: A Novel and Simple Software Tool for Automated Analysis of Monolayer Wound Healing Assays,” 46 Biotechniques 265-74 (2009), the entire disclosures of which are each incorporated by reference herein, describe a software program (called “TScratch”) that uses an advanced edge detection method to perform automated image analysis to find the wound area. The TScratch program uses an algorithm based on a curvelet transform to define the wound areas, and is able to reproducibly quantify wound area. Even though this method is automated and somewhat increases throughput over the conventional manual analysis, the detection algorithm is overly complex, takes too much time to process an image, and can miss smaller features of the wound.

Further background principles are described in: U.S. Pat. No. 6,642,018; R. van Horssen et al., Crossing Barriers: The New Dimension of 2D Cell Migration Assays, 226 J. Cell Physiology 288-90 (2011); Menon et al., “Flourescence-Based Quantitative Scratch Wound Healing Assay Demonstrating the Role of MAPKAPK-2/3 in Fibroblast Migration,” 66 Cell Motility Cytoskeleton 1041-47 (2009); D. Horst et al., “The Cancer Stem Cell Marker CD133 Has High Prognostic Impact But Unknown Functional Relevance for the Metastasis of Human Colon Cancer,” 219 J. Pathology 427-34 (2009); K. T. Wilson et al., “Inter-Conversion of Neuregulin2 Full and Partial Agonists for ErbB4,” 364 Biochemical & Biophysical Res. Comm'ns 351-57 (2007); M. R. Koller et al., “High-Throughput Laser-Mediated In Situ Cell Purification with High Purity and Yield,” 61 Cytometry A 153-61 (2004); and S. S. Hobbs et al., “Neuregulin Isoforms Exhibit Distinct Patterns Of Erbb Family Receptor Activation,” 21 Oncogene 8442-52 (2002). Each of the above listed references is hereby expressly incorporated by reference in its entirety. This listing is not intended as a representation that a complete search of all relevant prior art has been conducted or that no better reference than those listed above exist; nor should any such representation be inferred.

### DESCRIPTION OF INVENTION

The present application discloses one or more of the features recited in the appended claims and/or the following features, alone or in any combination.

According to one aspect, a method comprises applying a texture filter to a bright field image of a wound healing assay, generating a wound mask image in response to an output of the texture filter, and determining a wound area of the wound healing assay by counting a number of pixels in the wound mask image corresponding to the wound area.

In some embodiments, applying the texture filter may comprise applying an entropy filter to the bright field image of the wound healing assay. In other embodiments, applying the texture filter may comprise applying a range filter to the bright field image of the wound healing assay. In still other embodiments, applying the texture filter may comprise applying a standard deviation filter to the bright field image of the wound healing assay. One or more parameters of the texture filter may be user defined.

In some embodiments, the method may further comprise cropping the bright field image of the wound healing assay prior to applying the texture filter. Generating the wound mask image may comprise applying a pixel threshold to the output of the texture filter to generate a binary image. Generating the wound mask image may further comprise inverting the binary image. Generating the wound mask image may further comprise removing artifacts from the binary image.

In some embodiments, the method may further comprise generating an overlay image in response to the wound mask image, the overlay image comprising an outline of the wound area superimposed on the bright field image of the wound healing assay.

According to another aspect, one or more non-transitory, computer-readable media may comprise a plurality of instructions that, when executed by a processor, cause the processor to apply a texture filter to a bright field image of a wound healing assay, generate a wound mask image in response to an output of the texture filter, and determine a wound area of the wound healing assay by counting a number of pixels in the wound mask image corresponding to the wound area.

In some embodiments, the plurality of instructions may cause the processor to apply the texture filter by applying an entropy filter to the bright field image of the wound healing assay. In other embodiments, the plurality of instructions may cause the processor to apply the texture filter by applying a range filter to the bright field image of the wound healing assay. In still other embodiments, the plurality of instructions may cause the processor to apply the texture filter by applying a standard deviation filter to the bright field image of the wound healing assay. The plurality of instructions may cause the processor to apply the texture filter to the bright field image of the wound healing assay using one or more user defined parameters.

In some embodiments, the plurality of instructions may further cause the processor to crop the bright field image of the wound healing assay prior to applying the texture filter. The plurality of instructions may further cause the processor to apply a pixel threshold to the output of the texture filter to generate a binary image. The plurality of instructions may further cause the processor to invert the binary image. The plurality of instructions may further cause the processor to remove artifacts from the binary image.

In some embodiments, the plurality of instructions may cause the processor to generate an overlay image using the wound mask image, the overlay image comprising an outline of the wound area superimposed on the bright field image of the wound healing assay.

According to yet another aspect, an apparatus may comprise an automated imaging system configured to obtain a bright field image of a wound healing assay, one or more non-transitory, computer-readable media as described above, and a processor configured to control the automated imaging system and to execute the plurality of instructions stored on the one or more non-transitory, computer-readable media.

### BRIEF DESCRIPTION OF DRAWINGS

The detailed description below particularly refers to the accompanying figures in which:

FIG. 1 illustrates one embodiment of a quantitative image analysis algorithm for analyzing bright field images of a wound healing assay;

FIG. 2 illustrates bright field images of a wound healing assay at various time intervals, as well as the corresponding wound masks generated by the quantitative image analysis algorithm of FIG. 1;

FIG. 3A illustrates the results of a wound healing assay measuring the effect of varying doses of Neuregulin 2β on the healing of wounds in a culture of MCF7 cells, developed using the quantitative image analysis algorithm of FIG. 1; and

FIG. 3B illustrates a dose response curve of Neuregulin 2β on the healing of wounds in a culture of MCF7 cells, developed using the quantitative image analysis algorithm of FIG. 1.

Similar elements are labeled using similar reference numerals throughout the figures.

### BEST MODE(S) FOR CARRYING OUT THE INVENTION

While the concepts of the present disclosure are susceptible to various modifications and alternative forms, specific exemplary embodiments thereof have been shown by way of example in the drawings and will herein be described in detail. It should be understood, however, that there is no intent to limit the concepts of the present disclosure to the particular forms disclosed, but on the contrary, the intention is to cover all modifications, equivalents, and alternatives falling within the spirit and scope of the invention as defined by the appended claims.

In the following description, numerous specific details, such as the types and interrelationships of system components, may be set forth in order to provide a more thorough understanding of the present disclosure. It will be appreciated, however, by one skilled in the art that embodiments of the disclosure may be practiced without such specific details. In other instances, control structures, gate level circuits, and full software instruction sequences may not have been shown in detail in order not to obscure the disclosure. Those of ordinary skill in the art, with the included descriptions, will be able to implement appropriate functionality without undue experimentation.

References in the specification to “one embodiment,” “an embodiment,” “an illustrative embodiment,” etcetera, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Some embodiments of the disclosure may be implemented in hardware, firmware, software, or any combination thereof. Embodiments of the disclosure implemented in a computer network may include one or more wired communications links between components and/or one or more wireless communications links between components. Embodiments of the invention may also be implemented as instructions stored on one or more non-transitory, machine-readable media, which may be read and executed by one or more processors. A non-transitory, machine-readable medium may include any tangible mechanism for storing or transmitting information in a form readable by a machine (e.g., a computing device). For example, a non-transitory, machine-readable medium may include read only memory (ROM), random access memory (RAM), magnetic disk storage media, optical storage media, flash memory devices, and other tangible media.

The present disclosure relates to a quantitative image analysis algorithm to measure the results of a wound healing assay. This automated analysis method is based on texture segmentation and is able to rapidly distinguish between areas of an image that are covered by cells and the bare wound area. This algorithm may be performed using bright field images; thus, no fluorescence staining is required. Additionally, by using bright field microscopy the same wound sample can be monitored over many time points, and the data obtained may be normalized to the initial wound size for more accurate wound healing data. This automated analysis method makes no assumptions about the size or morphology of the wound area, so a true wound area is measured. This automated analysis method also allows any variety of initial wound shapes to be measured. The quantitative image analysis algorithm can process any wound healing image in any format. The quantitative image analysis algorithm does not require that images be spatially registered, which allows for tracking each wound at different time points.

The quantitative image analysis algorithm uses texture segmentation to discriminate between areas of a bright field image covered by cells and the bare wound area. Texture segmentation is less computational expensive than the curvelet transform, so the processing is faster—allowing for a higher throughput of samples. A texture filter examines the pixel intensities of the local neighborhood around each pixel in an image and returns this measurement as a pixel in an output image. In the illustrative embodiment, the quantitative image analysis algorithm may use three different types of texture filters: a range filter, a standard deviation filter, and/or an entropy filter. A range filter returns an image where each pixel value in the output image is the range of pixel values in the local neighborhood around the pixel in the input image. A standard deviation filter returns an image where each pixel value in the output image is the standard deviation of pixel values in the local neighborhood around the pixel in the input image. An entropy filter returns an image where each pixel value in the output image is the entropy, or disorder, of the local neighborhood around the pixel in the input image.

Each texture filter has its own strengths and weakness, and the appropriate texture filter may be used to analyze a set of bright field images from a particular wound healing assay. Additionally, the size of the local neighborhood—which impacts the accuracy of segmentation versus the speed of processing—may be user defined. A smaller neighborhood will be processed relatively faster but may produce relatively more errors, depending on the input image. In the illustrative embodiment, the texture filter type and the size of the local neighborhood are user defined to fit each set of bright field images to produce the best segmentation.

The illustrative embodiment of the quantitative image analysis algorithm has several outputs for each bright field image, and set of bright field images, of a wound healing assay. First, for each bright field image input to the algorithm, there is an output of a wound mask image. This wound mask image may be a binary image where the wound area has a value of 1 and the cell area has a value of 0. This wound mask image may be integrated to measure the area of the wound in pixels. The perimeter of the wound mask may also calculated. In the illustrative embodiment, the wound area and wound perimeter are recorded for every image in the set. This recorded data may then be used to calculate secondary measurements like the aspect ratio, the solidity, and/or the surface roughness of each wound. This data may be useful to researchers as they follow the healing progression of the wound. Finally, the first wound mask image generated for each assay (based on the first bright field image taken after wound creation) is used to define an initial wound area. By comparing subsequent wound mask images to this initial wound area, cells that have invaded the initial wound area can be identified. These cells may then be analyzed using bright field or fluorescence microscopy. Various types of cellular information, such as cell count, cell orientation, cell aspect ratio, and protein expression using immunofluorescence, may be gathered by the algorithm. All of these cellular parameters may be useful in the analysis of the wound healing assay.

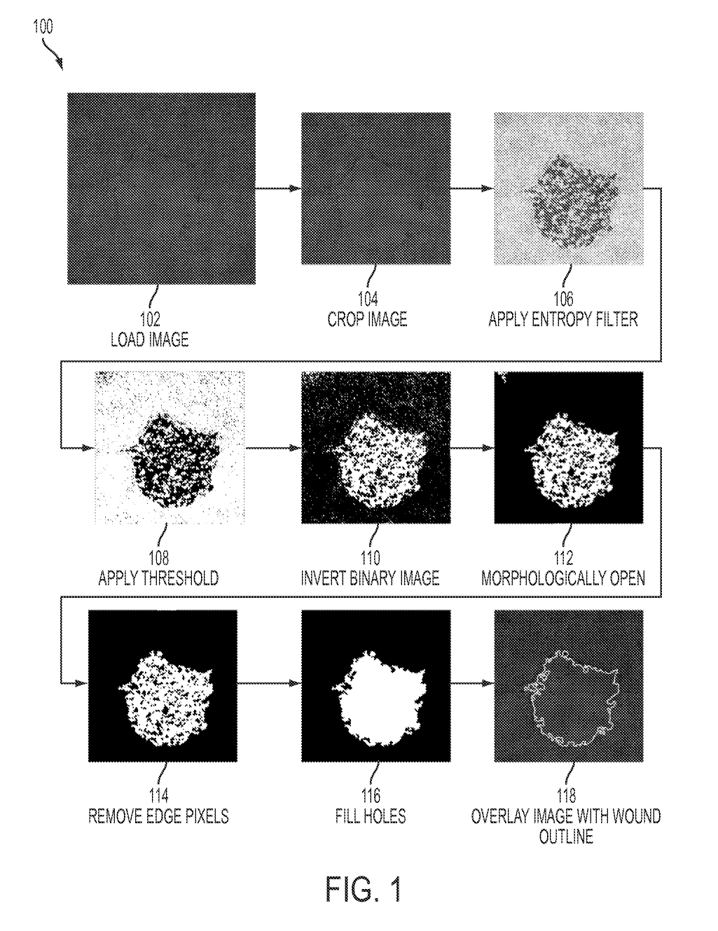

Referring now to FIG. 1, one embodiment of a quantitative image analysis algorithm 100 for analyzing bright field images of a wound healing assay is illustrated, including examples of the images processed at each stage of the algorithm 100. The algorithm 100 begins with a bright field image 102 of a wound healing assay. This image 102 may be obtained from any source capable of performing bright field microscopy on the wound healing assay. In some embodiments, the bright field image 102 may be obtained using a laser enabled analysis and processing (“LEAP”) instrument, commercially available from Cyntellect of San Diego, Calif. Software designed to perform the presently disclosed algorithm 100 may be run by the LEAP instrument itself, or may be run on a separate computing device which receives the bright field image 102 from a microscopy instrument.

The bright field image 102 may initially be cropped to a user defined size that just encompasses the entire wound (using the first bright field image 102 of the wound after wound creation). The cropped bright field image 104 reduces the amount of processing needed to be performed by the algorithm 100, making the algorithm 100 run faster.

A texture filter is then applied to the cropped bright field image 104 (or the bright field image 102, if not cropped). This analysis works because there is a fundamental difference in the disorder of areas covered by cells and the bare wound areas. In the illustrative embodiment, an entropy filter is applied that measures the local disorder of a 9×9 field of pixels surrounding each pixel and outputs a entropy image 106. Areas with large pixel intensity variation (i.e., cells) will appear bright, while smooth areas of the image (i.e., the wound) will appear dark in the entropy image 106. As noted above, in other embodiments, the algorithm 100 may apply a texture filter comprising a range filter or a standard deviation filter (instead of, or in addition to, the entropy filter).

In the illustrative embodiment of algorithm 100, the entropy image 106 is next converted to a thresholded binary image 108 by applying a simple pixel threshold. When this pixel threshold is applied, pixels with an intensity brighter than the threshold will become white, while pixel with an intensity lower than the threshold will become black. The thresholded binary image 108 may then be inverted, so that the bare wound region is white and the cell monolayer region is black in an inverted binary image 110.

Next, the wound region of the inverted binary image 110 may be morphologically opened to remove small artifact areas. A morphologically opened image 112 may be produced by performing an erosion operation followed by a dilation operation. This removes small areas that typically noise without affecting the larger wound region because the erosion and dilation operations have the same kernel size. The morphologically opened image 112 is dilated to smooth out the outer surface of the wound.

A morphological close is then applied to produce a continuous wound area. The morphologically closed image 114 is produced by first dilating and then eroding the morphologically opened image 112 using the same structural element (a 5-pixel disk). This operation functions to fill in the outer edges of the wound area that were distorted during the previous morphological opening process. During this step, the regions of the image 112 that do not overlap with a user defined rectangle are removed. This allows for the removal of large edge artifacts, without removing parts of the wound area that are near the edge of the image.

Finally, a wound mask image 116 is created by filling any “holes” (small black regions completely enclosed by the white wound region) in the morphologically closed image 114. In the wound mask image 116, each pixel of the wound area has a value of 1 and each pixel of the cell monolayer region has a value of 0. Thus, the pixel values of the wound mask image 116 may be summed to determine the wound area in the corresponding cropped bright field image 104. Optionally, the algorithm 100 may also use the wound mask image 116 to generate an overlay image 118 with a perimeter of the wound area superimposed onto the cropped bright field image 104. This overlay image 118 may be used for quality control and analysis by a user.

One illustrative embodiment of the quantitative image analysis algorithm is presented in Appendix A, using the MATLAB scripting language. In this embodiment, bright field images 102 are located in a folder for each wound healing assay, and named using the naming convention “[timepoint][well].tif” (e.g., “hr48WellG3.tif” represents an image of the wound in well G3 of a 96 well plate recorded 48 hours after wound creation). The images may then be automatically loaded by the script based upon time point and well number. The script of Appendix A saves a calculated wound area into a tab delimited text file for each time point. The script also saves copies of the cropped bright field image 104, the binary wound mask image 116, and the overlay image 118. These images 104, 116, 118 may be used to monitor the effectiveness of the algorithm in determining the proper wound area. In other embodiments, the software may also include a graphical user interface and/or may automatically generate a healing response curves for each well over time.

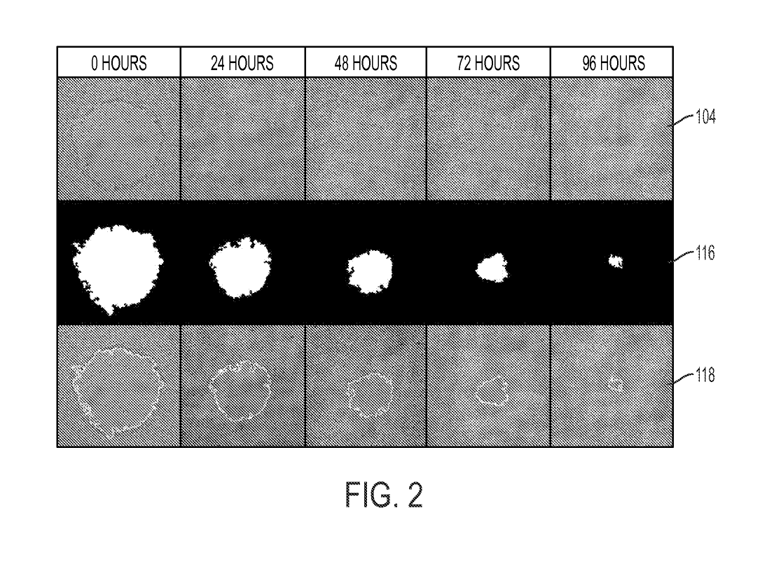

Illustrative embodiments of the quantitative image analysis algorithm 100 have been tested multiple times and have provided robust and dependable wound healing assay analysis. By way of example, the binary field images 102 of several wound healing assays were measured at 24 hour time points (up to 96 hours). FIG. 2 shows the cropped bright field image 104, the binary wound mask image 116, and the overlay image 118 that were obtained when one of the binary field image 102 was processed using the quantitative image analysis algorithm 100. In this experiment, the algorithm took 90 minutes to process five time points for each wound healing assay in a 96 well plate (i.e., a total of 480 bright point images 102 being analyzed). Thus, on average, the algorithm 100 took eleven seconds to analyze each bright field image 102. It will be appreciated by those of skill in the art that this time could be improved dramatically by moving the algorithm 100 to a standalone C++ executable (instead of running the algorithm 100 as a MATLAB script).

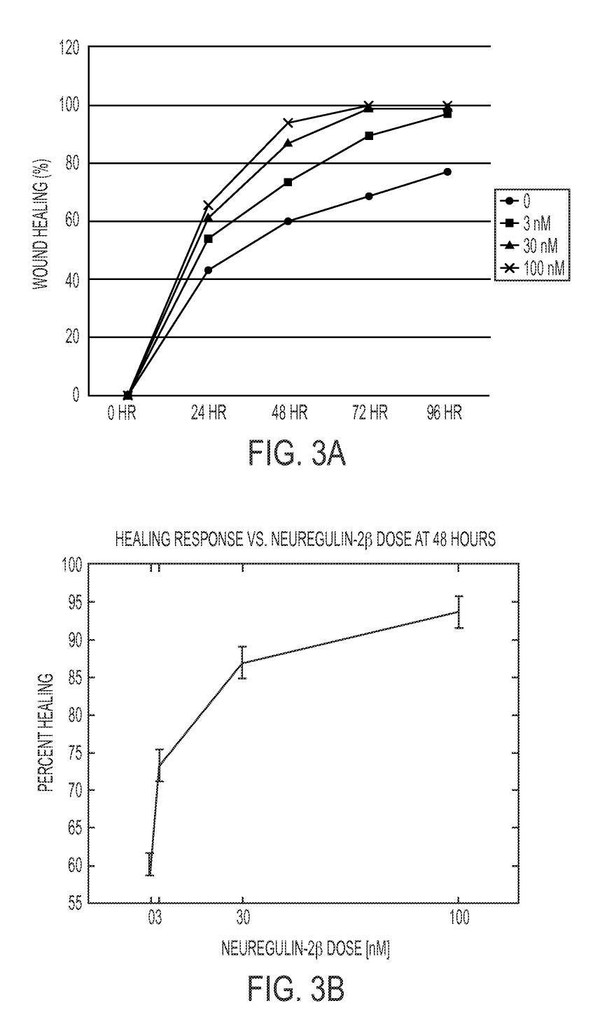

Furthermore, the data produced by the quantitative image analysis algorithm 100 matches traditional wound healing assay data. FIGS. 3A and 3B, which display the percentage of wound healing using the wound area calculated by the algorithm 100 at different time points, demonstrate an expected dose-dependent increase in healing when MCF7 cells are treated with the growth factor neuregulin 2β. FIG. 3A illustrates a healing curve of 4 different doses of Neuregulin 2β showing that the treated cells healed faster (as expected). FIG. 3B illustrates a dose response curve of Neuregulin 2β on healing 48 hours after wound creation. These graphs illustrate that the algorithm 100 accurately calculate the wound areas of a wound healing assay over time.

In some embodiments, the quantitative image analysis algorithm 100 may be constructed into a standalone executable with a graphical user interface (“GUI”) for the analysis of image sets from wound healing assays. Such an executable may allow the user to crop the bright field images 102 input to the algorithm 100. These embodiments may also allow the user to choose which type of texture filter to apply to the cropped bright field image 104, the size of the neighborhood to use, and the threshold value. The GUI may allow the user to select which wound and individual cell parameters are to be measured and stored in an output data file. In some embodiments, the user may be able to batch process entire image sets and/or perform real-time analysis on a single image to set the appropriate segmentation conditions. In other embodiments, the algorithm 100 could be incorporated into an image analysis software package. In still other embodiments, the algorithm 100 may be integrated into the software of an automated imaging system (e.g., the LEAP instrument) to perform real-time wound healing assay analysis.

While certain illustrative embodiments have been described in detail in the foregoing description and in Appendix A, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the apparatus, systems, and methods described herein. It will be noted that alternative embodiments of the apparatus, systems, and methods of the present disclosure may not include all of the features described yet still benefit from at least some of the advantages of such features. Those of ordinary skill in the art may readily devise their own implementations of the apparatus, systems, and methods that incorporate one or more of the features of the present invention and fall within the spirit and scope of the present disclosure.

```
APPENDIX A
% Texture Segmentation to determine wound size
clear
%define timepoint and well number arrays for loop
tm=[0 24 48 72 96];
well=[‘A’ ‘B’ ‘C’ ‘D’ ‘E’ ‘F’ ‘G’ ‘H’];
%generate rectangle for elimination of stray regions
r=zeros(241001, 1);
c=r;
m=1;
%generate wound area arrays
WoundArea=zeros(8,12);
for(k=300:900)
      for(l=500:900)
            r(m)=l;
            c(m)=k;
            m=m+1;
      end
end
onearray=ones(1301,1301);
      for(i=1:5)
            for(j=1:8)
                  for(z=1:12)
                  %load current mosaic image
                  file=[‘hr’ num2str(tm(i)) ‘Well’ well(j) num2str(z)];
                  %file=‘0hrC’;
                  I = imread([file ‘.tif’]);
                  %figure, imshow(I); %display original image
                  %crop image to reduce size, keeping wounds
                  cropI=imcrop(I, [100 100 1300 1300]);
                  %figure, imshow(cropI);
                  E=entropyfilt(cropI); %Apply entropy filter to create
                  texture image
                  Eim=mat2gray(E); %rescale entropy matrix to a
                  displayable image
                  BW1 = im2bw(Eim, .6);
                  inBW1=onearray-BW1;
                  inBW2=bwareaopen(inBW1, 700);
                  inBW3=bwmorph(inBW2, ‘dilate’);
                  se=strel(‘disk’, 5);
                  inBW4=imclose(inBW3, se);
                  inBW5 = bwselect(inBW4,c,r,4);
                  inBW6=imfill(inBW5, ‘holes’);
                  PmI=bwperim(inBW6);
                  PmI2=imdilate(PmI, se);
                  uPmI=uint16(PmI2);
                  matPmI=uPmI.*65536;
                  combined=matPmI+cropI;
                  combI=mat2gray(combined);
                  imshow(combI);
                  imwrite(combI, [‘Perimeter ’ file ‘.tif’], ‘tif’);
                  imwrite(cropI, [‘cropped ’ file ‘.tif’], ‘tif’);
                  imwrite(inBW6, [‘Filled wound mask ’ file ‘.tif’],
                  ‘tif’);
                  fiWoundarea=sum(inBW6);
                  fWoundArea(j,z)=sum(fiWoundarea);
                  Perim=sum(PmI);
                  fperim(j,z)=sum(Perim);
            end
      end
      foutfilename=[‘FilledWoundArea’ num2str(tm(i)) ‘hr.txt’];
      dlmwrite(foutfilename, fWoundArea, ‘delimiter’, ‘\t’, ‘newline’,
      ‘pc’);
      poutfilename=[‘Perimeter’ num2str(tm(i)) ‘hr.txt’];
      dlmwrite(poutfilename, fperim, ‘delimiter’, ‘\t’, ‘newline’, ‘pc’);
end
```

1. A method comprising:
applying a texture filter to a bright field image of a wound healing assay;
generating a wound mask image in response to an output of the texture filter; and
determining a wound area of the wound healing assay by counting a number of pixels in the wound mask image corresponding to the wound area.

2. The method of claim 1, wherein applying the texture filter comprises applying an entropy filter to the bright field image of the wound healing assay.

3. The method of claim 1, wherein applying the texture filter comprises applying a range filter to the bright field image of the wound healing assay.

4. The method of claim 1, wherein applying the texture filter comprises applying a standard deviation filter to the bright field image of the wound healing assay.

5. The method of claim 1, wherein one or more parameters of the texture filter are user defined.

6. The method of claim 1, further comprising cropping the bright field image of the wound healing assay prior to applying the texture filter.

7. The method of claim 1, wherein generating the wound mask image comprises applying a pixel threshold to the output of the texture filter to generate a binary image.

8. The method of claim 7, wherein generating the wound mask image further comprises inverting the binary image.

9. The method of claim 8, wherein generating the wound mask image further comprises removing artifacts from the binary image.

10. The method of claim 1 further comprising generating an overlay image in response to the wound mask image, the overlay image comprising an outline of the wound area superimposed on the bright field image of the wound healing assay.

11. One or more non-transitory, computer-readable media comprising a plurality of instructions that, when executed by a processor, cause the processor to:
apply a texture filter to a bright field image of a wound healing assay;
generate a wound mask image in response to an output of the texture filter; and
determine a wound area of the wound healing assay by counting a number of pixels in the wound mask image corresponding to the wound area.

12. The one or more non-transitory, computer-readable media of claim 11, wherein the plurality of instructions cause the processor to apply the texture filter by applying an entropy filter to the bright field image of the wound healing assay.

13. The one or more non-transitory, computer-readable media of claim 11, wherein the plurality of instructions cause the processor to apply the texture filter by applying a range filter to the bright field image of the wound healing assay.

14. The one or more non-transitory, computer-readable media of claim 11, wherein the plurality of instructions cause the processor to apply the texture filter by applying a standard deviation filter to the bright field image of the wound healing assay.

15. The one or more non-transitory, computer-readable media of claim 11, wherein the plurality of instructions cause the processor to apply the texture filter to the bright field image of the wound healing assay using one or more user defined parameters.

16. The one or more non-transitory, computer-readable media of claim 11, wherein the plurality of instructions further cause the processor to crop the bright field image of the wound healing assay prior to applying the texture filter.

17. The one or more non-transitory, computer-readable media of claim 11, wherein the plurality of instructions further cause the processor to apply a pixel threshold to the output of the texture filter to generate a binary image.

18. The one or more non-transitory, computer-readable media of claim 17, wherein the plurality of instructions further cause the processor to invert the binary image.

19. The one or more non-transitory, computer-readable media of claim 18, wherein the plurality of instructions further cause the processor to remove artifacts from the binary image.

20. The one or more non-transitory, computer-readable media of claim 11, wherein the plurality of instructions cause the processor to generate an overlay image using the wound mask image, the overlay image comprising an outline of the wound area superimposed on the bright field image of the wound healing assay.

21. Apparatus comprising:
an automated imaging system configured to obtain a bright field image of a wound healing assay;
and
a processor configured to:
control the automated imaging system to obtain the bright field image of the wound healing assay;
apply a texture filter to the bright field image of the wound healing assay;
generate a wound mask image in response to an output of the texture filter; and
determine a wound area of the wound healing assay by counting a number of pixels in the wound mask image corresponding to the wound area.

22. The apparatus of claim 21, wherein the processor is configured to apply the texture filter by applying an entropy filter to the bright field image of the wound healing assay.

23. The apparatus of claim 21, wherein the processor is configured to apply the texture filter by applying a range filter to the bright field image of the wound healing assay.

24. The apparatus of claim 21, wherein the processor is configured to apply the texture filter by applying a standard deviation filter to the bright field image of the wound healing assay.

25. The apparatus of claim 21, wherein the processor is configured to apply the texture filter to the bright field image of the wound healing assay using one or more user defined parameters.

26. The apparatus of claim 21, wherein the processor is further configured to crop the bright field image of the wound healing assay prior to applying the texture filter.

27. The apparatus of claim 21, wherein the processor is further configured to apply a pixel threshold to the output of the texture filter to generate a binary image.

28. The apparatus of claim 27, wherein the processor is further configured invert the binary image.

29. The apparatus of claim 28, wherein the processor is further configured to remove artifacts from the binary image.

30. The apparatus of claim 21, wherein the processor is further configured to generate an overlay image using the wound mask image, the overlay image comprising an outline of the wound area superimposed on the bright field image of the wound healing assay.
